(19) United States
(12) Patent Application Publication
(10) Pub. No.: US 2007/0257789 A1
(43) Pub. Date: Nov. 8, 2007

(54) Adjusting Alarm Drive Pulse for Changes in Temperature and Supply Voltage Via Microcontroller

(75) Inventor: Grant C. Juel, Boise, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Preco Electronics, Inc., Boise, ID (US)

(21) Appl. No.: 11/681,108

(22) Filed: Mar. 1, 2007

Related U.S. Application Data
(60) Provisional application No. 60/778,822, filed on Mar. 2, 2006.

(51) Int. Cl. G08B 29/02

(52) U.S. Cl. 340/506

(57) ABSTRACT

An audible alert device determines the effect of environmental factors upon the output sound pressure level of a transducer and establishes drive signal parameters adapted to the current operating environment. The drive signal parameters are based upon supply voltage, ambient temperature and/or resonant frequency. The drive signal is optionally a pulse width modulated signal for which the drive signal parameters represent the frequency and duty-cycle of the drive signal pulses. The audible alert device generates the drive signal using the drive signal parameters and delivers it to the transducer thereby controlling the output sound pressure level.

### CROSS-REFERENCES TO RELATED APPLICATIONS

The present application claims benefit under 35 USC 119(e) of U.S. Provisional Application No. 60/778,822, filed on Mar. 2, 2006, entitled “Adjusting Alarm Drive Pulse For Changes In Temperature And Supply Voltage Via Microcontroller” the content of which is incorporated herein by reference.

### BACKGROUND OF THE INVENTION

The present invention relates to audible alert devices, and more particularly to controlling the operation of such devices.

Audible alert devices are used in a variety of applications. In some instances, audible alert devices are configured as backup alarms that may be mounted to heavy equipment such as forklifts or tractor-trailers. Backup alarms are activated when a reverse gear is used and provide important warnings to those nearby. This promotes safety and helps to reduce accidents.

Audible alert devices such as backup alarms are typically calibrated at the factory to operate at a predetermined output level before they are deployed for use in the field. The alarm, for example, may be rated at a specified decibel level which may be established by governmental regulation or industry standards. Unfortunately, such factory calibration cannot take into account the effect of environmental factors. As a result, there may be uncontrolled variation in audible output when the device is operated. This variation reduces the effectiveness of the audible alert device. Thus, there is a need in the art for an audible alert device with improved performance that addresses the effect of environmental factors.

### BRIEF SUMMARY OF THE INVENTION

According to one embodiment of the present invention, a method of controlling an audible alert device includes receiving a supply voltage signal and determining a level of the supply voltage. The method also includes adjusting drive signal parameters based upon the level of the supply voltage and generating a drive signal according to the drive signal parameters. The method further includes delivering the drive signal to a transducer to control the audible output of the transducer.

In some embodiments, the drive signal comprises a pulse-width modulated signal and the drive signal parameters include a duty-cycle of the drive signal pulses. The method may include reducing the duty cycle of the drive signal pulses if the level of the supply voltage is determined to be higher than a reference value associated with the audible alert device and increasing the duty cycle of the drive signal pulses if the level of the supply voltage is determined to be lower than the reference value.

The method may also include determining a resonant frequency of the transducer and adjusting the drive signal parameters to operate the transducer at the frequency determined to be the resonant frequency. A frequency of the drive signal pulses may be adjusted according to the transducer resonant frequency. In some embodiments, the transducer resonant frequency is identified by generating a series of drive signal pulses corresponding to predetermined frequency values and detecting a feedback signal from the transducer in response to the series of drive signal pulses. An initial set of drive signal parameters may be established with reference to transducer data such as the transducer's physical characteristics.

According to another embodiment of the present invention, an audible alert device comprises an adapter configured to receive a supply voltage signal. The device also includes a voltage monitor configured to produce a first input signal representative of a level of the supply voltage signal. The device includes a control block configured to adjust drive signal parameters based upon the first input signal and a drive signal generator configured to generate the drive signal using the drive signal parameters. The apparatus further includes a transducer configured to receive the drive signal and to produce an audible output that varies according to the drive signal.

In some embodiments, the audible alert device includes a voltage divider configured to receive the supply voltage and to produce the first input signal. The audible alert device may also include an analog-to-digital converter configured to produce a digital signal representative of the first input signal. In other embodiments, the audible alert device includes an RC network that receives the supply voltage such that the first input signal corresponds to a voltage across the capacitor. The control block may be configured to measure a charging time required for the first input signal to reach a predetermined level and to determine a level of the supply voltage based upon the charging time. The audible alert device may include a thermistor configured to establish a voltage signal representative of the ambient temperature of the audible alert device. In some embodiments, the audible alert device includes a microcontroller.

### BRIEF DESCRIPTION OF THE DRAWINGS

FIG. 1 is a simplified functional block diagram of an audible alert device in accordance with one embodiment of the present invention.

FIG. 2 is a block diagram of an operating environment monitor according to an embodiment of the present invention.

FIGS. 3A-3C illustrate control circuits that may be used with the operating environment monitor of FIG. 2 according to embodiments of the present invention.

FIG. 4 is a simplified block diagram of a control block according to one embodiment of the present invention.

FIG. 5 is an exemplary resonant frequency diagram in accordance with one embodiment of the present invention.

FIG. 6 is a flowchart depicting a method for controlling an audible alert device according to an embodiment of the present invention.

### DETAILED DESCRIPTION OF THE INVENTION

An audible alert device in accordance with the present invention determines the effect of environmental factors upon the output sound pressure level of a transducer and establishes drive signal parameters adapted to the current operating environment. The drive signal parameters are based upon supply voltage, ambient temperature and/or resonant frequency. The drive signal is optionally a pulse width modulated signal for which the drive signal parameters represent the frequency and duty-cycle of the drive signal pulses. The audible alert device generates the drive signal using the drive signal parameters and delivers it to the transducer thereby controlling the output sound pressure level.

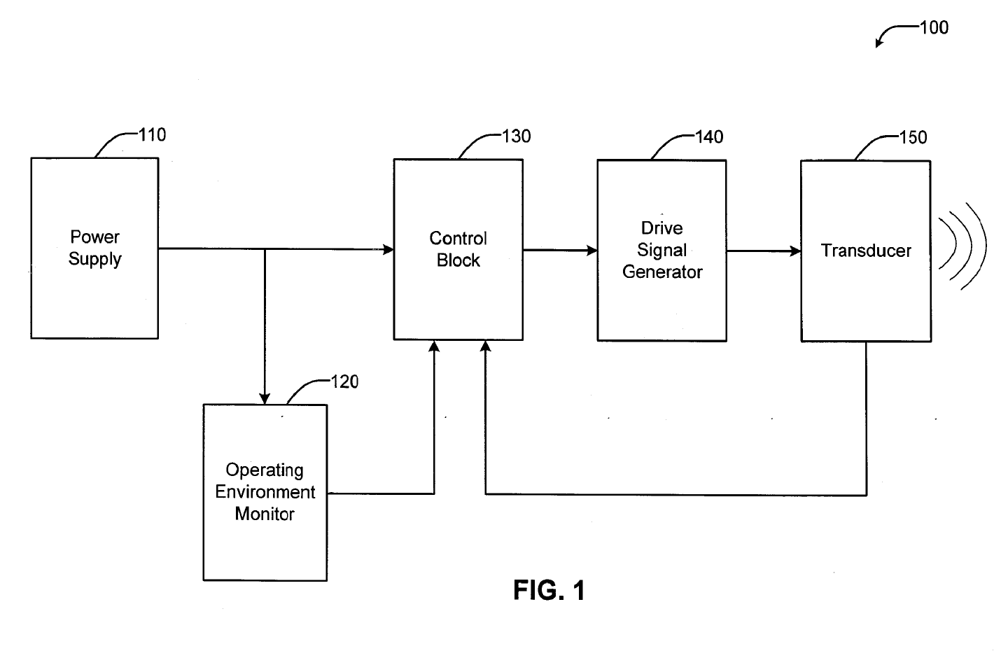

FIG. 1 is a simplified functional block diagram of an audible alert device 100 in accordance with an embodiment of the present invention. Audible alert device 100 is shown as including power supply 110, operating environment monitor 120, control block 130, drive signal generator 140, and transducer 150. In operation, audible alert device 100 adjusts the output of transducer 150 to maintain a steady sound pressure level notwithstanding variation in its operating environment.

Power supply 110 provides the electrical power that is used by audible alert device 100. Power supply 110 generally includes one or more batteries configured to supply a specified operating voltage. In a backup alarm configuration, for example, a supply voltage of 12-36V may be received from a vehicle battery. Audible alert device 100 uses the supply voltage to drive transducer 150 at a predetermined audio output level.

Audible alert device 100 is configured to monitor the supply voltage and ambient temperature and to maintain the sound pressure level of transducer 150 at a substantially constant value. As shown, operating environment monitor 120 receives the supply voltage signal and determines a level of the supply voltage. For example, the supply voltage may increase as a result of charging the vehicle battery or it may decrease due to heavy loading of the vehicle's electrical system. Operating system monitor 120 provides information about the level of the supply voltage to control block 130.

Operating system monitor 120 also determines an ambient temperature of the audible alert device. It is known that physical properties of a transducer may change with temperature. Accordingly, operating system monitor 120 provides ambient temperature information to control block 130 so that the sound pressure level of transducer 150 can be adjusted to account for the effect of temperature.

Control block 130 sets and adjusts parameters used to produce the drive signal and to thereby control the output of transducer 150. The drive signal parameters are based upon inputs provided by operating system monitor 120 and may also be determined according to operating characteristics of transducer 150. For example, control block 130 may store data about the size and type of transducer 150 or about its resonant frequency or about other performance related characteristics. Transducer data may be based upon manufacturing specifications or it may be determined as the result of a testing process.

Drive signal generator 140 produces an output signal having the characteristics that are determined by the drive signal parameters. In some embodiments, drive signal generator 140 produces a pulse-width modulated output signal wherein the duty cycle of each pulse and the pulse frequency (or period) are determined by the drive signal parameters. The output of drive signal generator 140 is delivered to transducer 150 and controls the frequency and amplitude of the audible alert. By monitoring its operating environment and adjusting for environmental factors, audible alert device 100 maintains a precise control of the transducer output level.

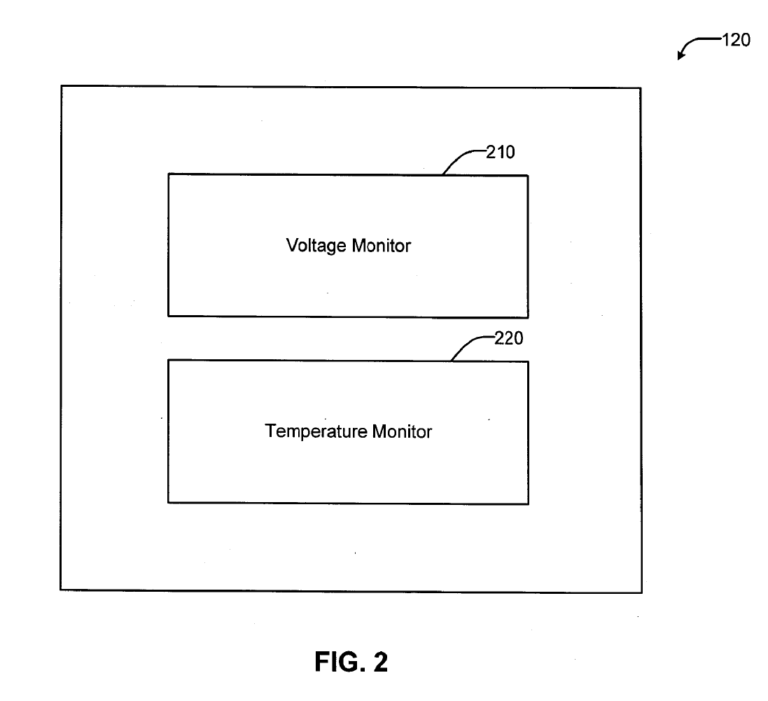

FIG. 2 is a block diagram of an operating environment monitor 120 according to embodiments of the present invention. As shown, operating environment monitor 120 includes voltage monitor 210 and temperature monitor 220. Voltage monitor 210 determines an operating voltage level based upon the supply voltage signal. This may be accomplished in several ways.

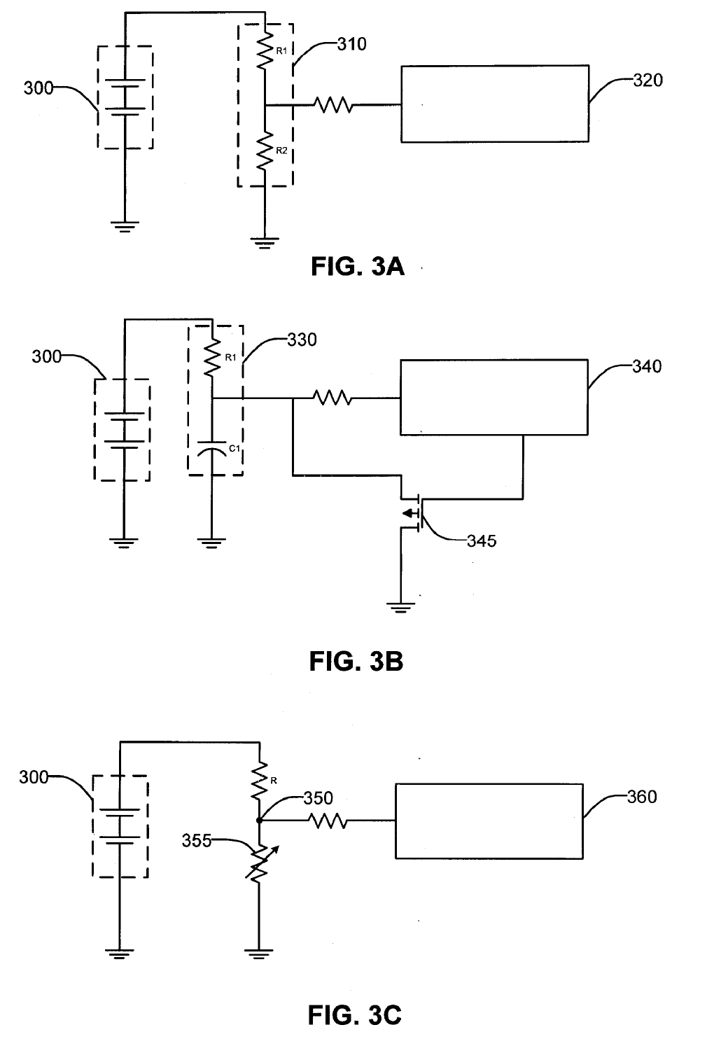

With reference to FIG. 3A, a control circuit having a voltage divider 310 is shown. Voltage divider 310 receives a signal from supply voltage 300 and generates an output signal by dividing the supply voltage according to a ratio determined by resistors R1 and R2. The output signal is delivered to integrated circuit 320. Integrated circuit 320 includes an analog-to-digital converter (not shown) which produces a digital value that is representative of the supply voltage level. In some embodiments, the digital value indicates whether supply voltage 300 is higher or lower than a reference associated with the audible alert device and thus indicates the extent to which the measured voltage differs from a reference voltage. The digital value is provided to control block 130 and used to establish drive signal parameters.

FIG. 3B depicts an alternative control circuit for determining the supply voltage level. As shown, supply voltage 300 is delivered to RC network 330 and charges capacitor C1. Integrated circuit 340 monitors the time required to charge the capacitor to a predetermined voltage level. Integrated circuit 340 then compares the time required to charge the capacitor to a reference value. A fast charging time indicates a relatively high supply voltage whereas a slow charging time indicates a relatively low supply voltage. Between measurements, integrated circuit 340 discharges capacitor C1 by creating a path to the ground potential through transistor 345.

Operating environment monitor 120 also includes temperature monitor 220. Temperature monitor 220 determines an ambient temperature of audible alert device 100 through any known temperature sensing means. FIG. 3C shows one possible temperature sensing circuit comprising a thermistor. A resistance of thermistor 355 varies with its temperature. This variable resistance establishes the voltage at node 355 which is therefore representative of the ambient temperature. Integrated circuit 360 detects the voltage at node 355 and communicates temperature information to control block 130. In some embodiments, integrated circuits 320, 340, 360 are disposed in a microcontroller.

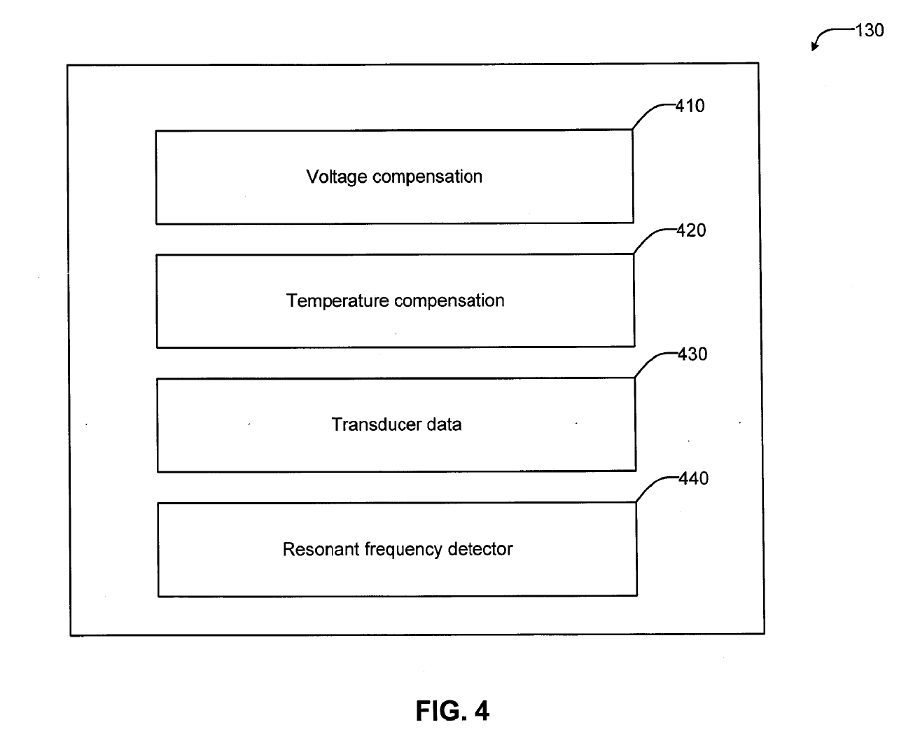

FIG. 4 is a simplified block diagram of a control block 130 according to embodiments of the present invention. As shown, control block 130 includes voltage compensation block 410, temperature compensation block 420, transducer data block 430, and resonant frequency detector block 440. All or only some of these blocks may be included in various embodiments of the invention to permit different combinations of monitoring and adjustment.

Control block 130 produces parameters that are used by drive signal generator 140 to control the output of transducer 150. In some embodiments, control block 130 stores transducer data 430 in a memory and retrieves it at the beginning of an operating cycle. Transducer data 430 may supply an initial set of drive signal parameters which are determined according to characteristics of transducer 150. For example, transducer data 430 may reflect initial parameters suitable for driving a 3″ speaker to an output level of 107 dB at a specified operating voltage if the audible alert device is configured in this manner.

Voltage compensation block 410 adjusts the drive signal parameters based upon the current level of the supply voltage. By way of illustration, if the audible alert device is configured for use with a 12V source and the supply voltage is detected as being only 11V, then voltage compensation block 410 adjusts the drive signal parameters to compensate for the voltage difference and to thereby maintain the sound pressure level at a substantially constant level. In some embodiments, voltage compensation block 130 determines an adjustment value with reference to a table or other data structure specifying a relationship between the supply voltage level and the drive signal parameters. In other embodiments, control block 130 determines the adjustment value by performing a calculation using one or more correlation coefficients.

Temperature compensation block 420 adjusts the drive signal parameters according to the ambient temperature. For example, transducer 150 may operate more efficiently in cold temperatures and its output may therefore increase as temperature decreases. Similarly, transducer 150 may operate less efficiently when the ambient temperature rises. Temperature compensation block 420 adjusts the drive signal parameters to compensate for differences in transducer sound pressure level due to ambient temperature. In some embodiments, temperature compensation block 420 determines an adjustment value with reference to a table or other data structure specifying a relationship between ambient temperature and the drive signal parameters. Temperature compensation block 420 may alternatively determine the adjustment value by performing a calculation using one or more correlation coefficients.

In this manner, control block 130 produces drive signal parameters that are based upon transducer characteristics, supply voltage level, and ambient temperature. Thus, for example, a low supply voltage and a relatively high ambient temperature may indicate that the drive signal parameters need to be adjusted to drive the transducer harder in order to maintain the specified output sound pressure level. On the other hand, if the supply voltage exceeds the specified value while at the same time ambient temperature is relatively high, drive signal parameters may represent a net adjustment based upon the relative magnitude of these factors. In other words, the drive signal parameters reflect conditions prevailing in the operating environment.

In some embodiments, drive signal generator 140 produces a pulse-width modulated (PWM) drive signal. The drive signal parameters for the PWM signal are set or adjusted by control block 130 and include a duty-cycle (“on-time”) of the drive signal pulses. By adjusting the pulse duty-cycle, environmental factors may be compensated for by driving transducer 150 as required to maintain a steady output sound pressure level. For example, based upon supply voltage and ambient temperature, control block 130 may determine that a net increase of 1 dB is required to offset environmental factors and maintain transducer output at a specified level (e.g., 96 dB). If it is known that an 11% increase in pulse duty-cycle corresponds to a 1 dB increase in sound pressure level, then control block 130 would increase the pulse duty-cycle parameter by 11% without changing the pulse frequency. In other words, the frequency of the generated pulses would be held constant but the “on-time” of each pulse would be increased by 11%.

Control block 130 also includes resonant frequency detector 440. Driving transducer 150 at its resonant frequency is efficient and produces a maximum sound pressure level output at a given source voltage. However, the resonant frequency of a transducer may change over time and may change based upon operating conditions. For example, resonant frequency may be altered if the transducer becomes wet. Similarly, mud or debris may accumulate on the transducer, changing the mass of its diaphragm and thus changing its resonant frequency.

Resonant frequency detector 440 adjusts drive signal parameters to operate transducer 150 at its resonant frequency. In some embodiments, a frequency sweep is performed when the audible alert device is activated. For example, control block 130 may generate a series of drive pulses corresponding to different transducer operating frequencies. Resonant frequency detector 440 monitors a feedback signal from transducer 150 at each of the operating frequencies and detects a level of the feedback signal.

In various embodiments, audible alert device 100 includes a high-impedance feedback network coupled with transducer 150. The high-impedance feedback network is configured to detect a back-emf signal from the transducer. Resonant frequency detector 440 monitors the transducer back-emf signal and, in one embodiment, determines the operating frequency that maximizes its amplitude. This value represents the resonant frequency of the transducer under current operating conditions.

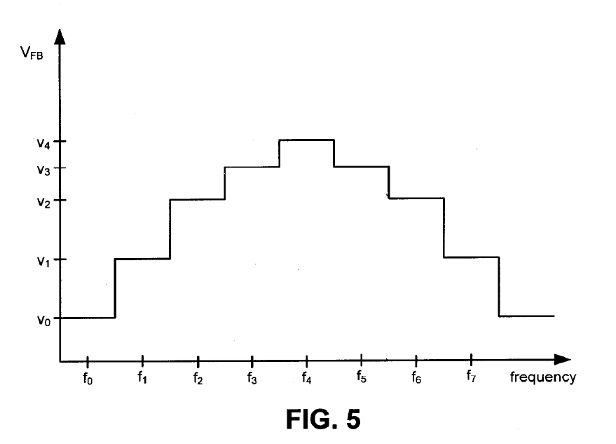

FIG. 5 is an exemplary frequency sweep diagram. Feedback signal V_{FB} is plotted with respect to transducer operating frequency. For simplicity, a sweep of eight discrete frequencies (f₀-f₇) is illustrated. However, it will be appreciated that the frequency sweep may cover more or fewer than eight frequencies and that it may, in some embodiments, include a continuous sweep of a predetermined frequency range. In an exemplary embodiment, the frequency sweep comprises 60 predetermined transducer operating frequencies separated at 10 Hz increments with a center frequency that is determined using transducer data 430.

Referring to FIG. 5, signal V_{FB} is shown reaching a maximum value of V₄ at frequency f₄. Frequency f₄ is therefore determined to be the resonant frequency. Resonant frequency detector 440 responds by adjusting the drive signal parameters so that the drive signal pulses are generated at the resonant frequency. This may include, for example, setting a pulse frequency parameter to the value f₄ or, equivalently, setting a pulse period parameter to the value 1/f₄. Drive signal generator 140 then generates the drive signal according to the established pulse duty-cycle and pulse frequency parameters. In this way, transducer 150 is operated efficiently to produce a steady sound pressure level.

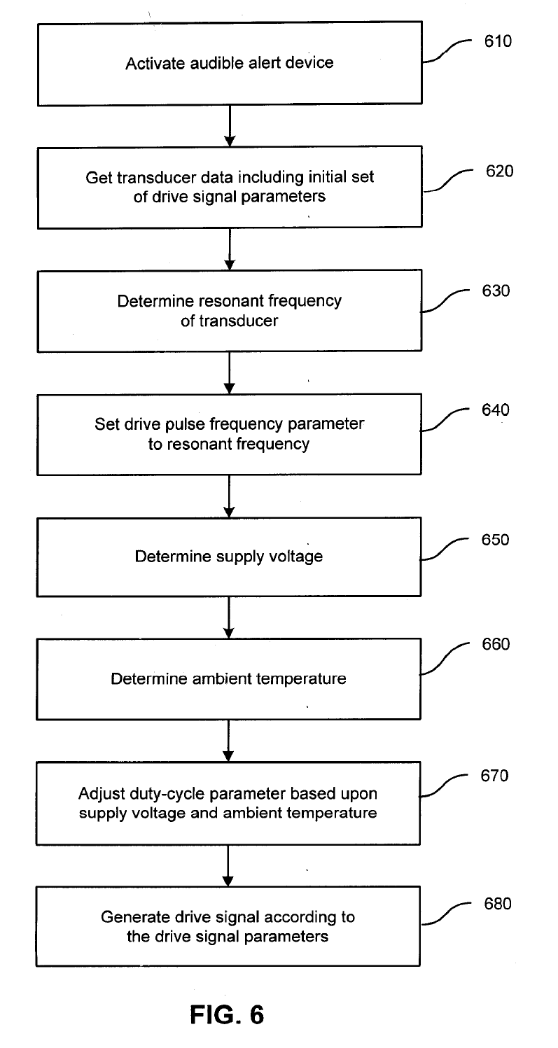

FIG. 6 is a flowchart depicting a method for controlling an audible alert device according to embodiments of the present invention. At step 610, the audible alert device is activated. For example, if the audible alert device is configured as a backup alarm, it may be triggered when a reverse gear of a vehicle is engaged. Next, at step 620, the audible alert device retrieves an initial set of drive signal parameters. The drive signal parameters, for example, may be based upon transducer data stored in a memory of the audible alert device and they may include an initial set of timer and/or counter values used to control the frequency and amplitude of the transducer's audible output.

At step 630, the audible alert device determines the resonant frequency of the transducer under current operating conditions. This may include performing a frequency sweep. In some embodiments, the audible alert device is configured to generate a series of warning beeps and it determines the resonant frequency by performing the frequency sweep at the start of a beep tone. For example, the audible alert device may prepend a series of frequency sweep pulses to the first beep tone that is generated. At step 640, the audible alert device sets drive signal parameters based upon the transducer resonant frequency. This may be accomplished by setting a timer value to produce drive signal pulses at the resonant frequency.

The audible alert device compensates for operating environment factors. At step 650, the supply voltage is determined in relation to its specified input voltage. Ambient temperature is also determined at step 660. Using information about the supply voltage and ambient temperature, the audible alert device adjusts drive signal parameters so that variation in sound pressure level due to these factors is avoided. In some embodiments, for example, audible alert device performs a lookup operation and retrieves values from a table or matrix based upon the current voltage and ambient temperature. The audible alert device may also perform a calculation to determine the net effect of the operating environment.

At step 670, audible alert device adjusts drive signal parameters based upon the supply voltage and ambient temperature by setting the duty-cycle of the drive signal pulses. At step 680, the audible alert device generates a drive signal adapted for the current operating environment using the drive signal parameters. The drive signal is applied to a transducer to generate audible output at a predetermined sound pressure level.

The above embodiments of the present invention are illustrative and not limiting. Various alternatives and equivalents are possible. Other additions, subtractions or modifications are obvious in view of the present disclosure and are intended to fall within the scope of the appended claims.

What is claimed is:

1. A method of controlling an audible alert device, the method comprising:
determining a supply voltage level of the audible alert device;
adjusting drive signal parameters based upon the supply voltage level;
generating a drive signal according to the drive signal parameters; and
delivering the drive signal to a transducer to control an audible output of the transducer.

2. The method of claim 1 wherein the drive signal comprises a pulse-width modulated signal and the drive signal parameters include a duty-cycle of the drive signal pulses.

3. The method of claim 2 wherein adjusting drive signal parameters further comprises establishing the duty-cycle of the drive signal pulses.

4. The method of claim 3 further comprising:
reducing the duty cycle of the drive signal pulses if the level of the supply voltage is determined to be higher than a reference value associated with the audible alert device.

5. The method of claim 4 further comprising:
increasing the duty cycle of the drive signal pulses if the level of the supply voltage is determined to be lower than a reference value associated with the audible alert device.

6. The method of claim 1 further comprising:
determining an ambient temperature of the audible alert device; and
adjusting the drive signal parameters based upon the ambient temperature of the audible alert device.

7. The method of claim 1 further comprising:
determining a resonant frequency of the transducer; and
adjusting the drive signal parameters based upon the frequency determined to be the resonant frequency.

8. The method of claim 7 wherein the drive signal comprises a pulse-width modulated signal and the drive signal parameters include a frequency of the drive signal pulses.

9. The method of claim 7 wherein determining the resonant frequency further comprises:
generating a series of drive signal pulses corresponding to predetermined frequency values; and
detecting a feedback signal from the transducer in response to the series of drive signal pulses.

10. The method of claim 1 wherein the drive signal is generated with reference to predetermined characteristics of the transducer.

11. A method of controlling an audible alert device, the method comprising:
retrieving initial drive signal parameters;
determining a supply voltage level of the audible alert device;
determining an ambient temperature of the audible alert device;
adjusting the drive signal parameters according to the supply voltage level and ambient temperature of the audible alert device;
generating a drive signal using the drive signal parameters; and
delivering the drive signal to a transducer to control an audible output of the transducer.

12. The method of claim 11 wherein the drive signal comprises a pulse-width modulated signal and the drive signal parameters include a duty-cycle of the drive signal pulses.

13. The method of claim 12 wherein adjusting the drive signal parameters further comprises establishing the duty-cycle of the drive signal pulses.

14. The method of claim 11 wherein the initial drive signal parameters are based upon predetermined characteristics of the transducer.

15. The method of claim 11 further comprising:
determining a resonant frequency of the transducer; and
adjusting the drive signal parameters based upon the frequency determined to be the resonant frequency.

16. The method of claim 15 wherein the drive signal comprises a pulse-width modulated signal and the drive signal parameters include a frequency of the drive signal pulses.

17. The method of claim 15 wherein determining the resonant frequency further comprises:
generating a series of drive signal pulses corresponding to predetermined frequency values; and
measuring a feedback signal from the transducer in response to the series of drive signal pulses.

18. An audible alert device comprising:
an adapter configured to receive a supply voltage signal;
a voltage monitor configured to produce a first input signal representative of a level of the supply voltage signal;
a control block configured to adjust drive signal parameters based upon the first input signal;
a drive signal generator configured to generate the drive signal using the drive signal parameters; and
a transducer configured to receive the drive signal and to produce an audible output that varies according to the drive signal.

19. The audible alert device of claim 18 wherein the drive signal comprises a pulse-width modulated signal and the drive signal parameters include a duty-cycle of the drive signal pulses.

20. The audible alert device of claim 19 wherein the control block is further configured to establish the duty cycle of the drive signal pulses based upon the first input signal.

21. The audible alert device of claim 20 wherein the control block reduces the duty cycle of the drive signal pulses if a level of the first input signal is determined to be higher than a reference value associated with the audible alert device.

22. The audible alert device of claim 21 wherein the control block increases the duty cycle of the drive signal pulses if a level of the first input signal is determined to be lower than a reference value associated with the audible alert device.

23. The audible alert device of claim 18 further comprising:
a temperature sensor configured to produce a second input signal representative of an ambient temperature of the audible alert device,
wherein the control block is configured to adjust the drive signal parameters based upon the first and second input signals.

24. The audible alert device of claim 18 further comprising:
a memory configured to store transducer data,
wherein the control block is further configured to access the transducer data in the memory and to produce the drive signal parameters based upon the transducer data and the first and second input signals.

25. The method of claim 18 wherein the control block is further configured to determine a resonant frequency of the transducer, and
the control block is configured to adjust the drive signal parameters based upon the frequency determined to be the resonant frequency.

26. The method of claim 25 wherein the drive signal comprises a pulse-width modulated signal and the drive signal parameters include a frequency of the drive signal pulses.

27. The method of claim 26 wherein the audible alert device is further configured to determine the resonant frequency by generating a series of drive signal pulses corresponding to predetermined frequency values and detecting a feedback signal from the transducer in response to the series of drive signal pulses.

28. The audible alert device of claim 18 further comprising:
a voltage divider configured to receive the supply voltage and to produce the first input signal.

29. The audible alert device of claim 18 further comprising:
an RC network configured to receive the supply voltage, the first input signal corresponding to a voltage across the capacitor, and
wherein the control block is configured to measure a charging time required for the first input signal to reach a predetermined level and to determine a level of the supply voltage based upon the charging time.

30. The device of claim 19 wherein the control block comprises a microcontroller.
